(19) United States
(12) Patent Application Publication
(10) Pub. No.: US 2014/0322397 A1
(43) Pub. Date: Oct. 30, 2014

(54) ASEPTIC HOT-BREWED PACKAGED COFFEE OR ESPRESSO BEVERAGE

(71) Applicant: David F. Mamo, (US)

(72) Inventor: David F. Mamo, Milford, MI (US)

(73) Assignee: David F. Mamo, Milford, MI (US)

(21) Appl. No.: 13/872,097

(22) Filed: Apr. 27, 2013

(51) Int. Cl. A23F 5/24

(52) U.S. Cl. CPC A23F 5/243
USPC 426/115; 426/594; 426/595

(57) ABSTRACT

An aseptic, hot-brewed packaged coffee or espresso beverage is disclosed. The hot-brewed coffee or espresso beverage includes a beverage package comprising a hollow sterile container having a base and an outlet opening, the container having a beverage cavity. The aseptic packaged coffee or espresso beverage also includes an aseptic brewed coffee or espresso beverage having a solubles concentration of about 0.8% to about 2.0% and a solubles yield of about 14% to about 27%, the beverage partially filling the beverage, cavity to provide a filled portion and an unfilled portion. The aseptic packaged coffee beverage also includes a sealed closure, the sealed closure configured to maintain an aseptic environment in the unfilled portion of the beverage cavity.

### FIELD OF THE INVENTION

The present invention related generally to packaged beverage and more particularly, to a packaged coffee beverage.

### BACKGROUND

Coffee is one of the most popular beverages in the world. It is brewed fresh daily for consumption in millions of homes around the world. It is also brewed fresh for sale in millions fill-service and fast-food restaurants, coffee shops, service stations, convenience stores and the like around the world. It is also brewed and sold in various packaged beverages that include coffee as a flavorant together with other ingredients; such as various milk by-products. It has also been sold in waxed paper or cardboard foil-lined containers, which have a limited shelf life that is extended by refrigeration, such that these beverages have been sold in the refrigerated sections of various groceries, convenience stores and the like.

Packaged coffee beverages have heretofore had one or more undesirable characteristics. First, many packaged coffee beverages are sold mixed with milk products and sugar or artificial sweeteners, which is undesirable to many users who prefer their coffee black, without either milk products or sugar. Second, many packaged coffee be are sold in packaging that requires refrigeration, or has preservatives added to extend the shelf life. Third, the packed coffee beverages are often sold as individual portions, rather than in packaging that can provide multiple portions Fourth, while freshly brewed coffee may be sold in containers that accommodate multiple portions, the packaging used is generally not intended or suitable for long term storage.

In view of the popularity of coffee beverages, it is desirable to develop a packaged coffee beverage that has the taste and aroma attributes of freshly brewed coffee, may be sold with or without being refrigerated, and has an extended shelf-life.

### SUMMARY OF THE INVENTION

In one exemplary embodiment, an aseptic, hot-brewed packaged coffee or espresso beverage is disclosed. The beverage includes a beverage package comprising a hollow container having a base and an outlet opening, the container having a beverage cavity. The packaged coffee beverage also includes an aseptic, hot-brewed brewed coffee beverage having a solubles concentration of about 0.8% to about 2.0% and a solubles yield of about 14% to about 27%, the beverage partially filling the beverage cavity to provide a filled portion and an unfilled portion. The aseptic, hot-brewed packaged coffee beverage also includes a sealed closure, the sealed closure configured to maintain an aseptic environment in the unfilled portion of the beverage cavity.

The above features and advantages and other features and, advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a cross-sectional view of an exemplary embodiment of a packaged coffee beverage as disclosed herein;

FIG. 2 is a cross-sectional view of a second exemplary embodiment of a packaged coffee beverage as disclosed herein;

FIG. 3 is a cross-sectional view of a third exemplary embodiment of a packaged coffee beverage as disclosed herein;

FIG. 4 is a cross-sectional view of a fourth exemplary embodiment of a packaged coffee beverage as disclosed herein;

FIG. 5 is a front plan view of a sealed closure for the packaged coffee beverage;

FIG. 6 is a bottom plan view of the sealed closure and seal of FIG. 4; and

FIG. 7 is a flowchart of a method of making a packaged coffee beverage as disclosed herein.

### DESCRIPTION OF THE EMBODIMENTS

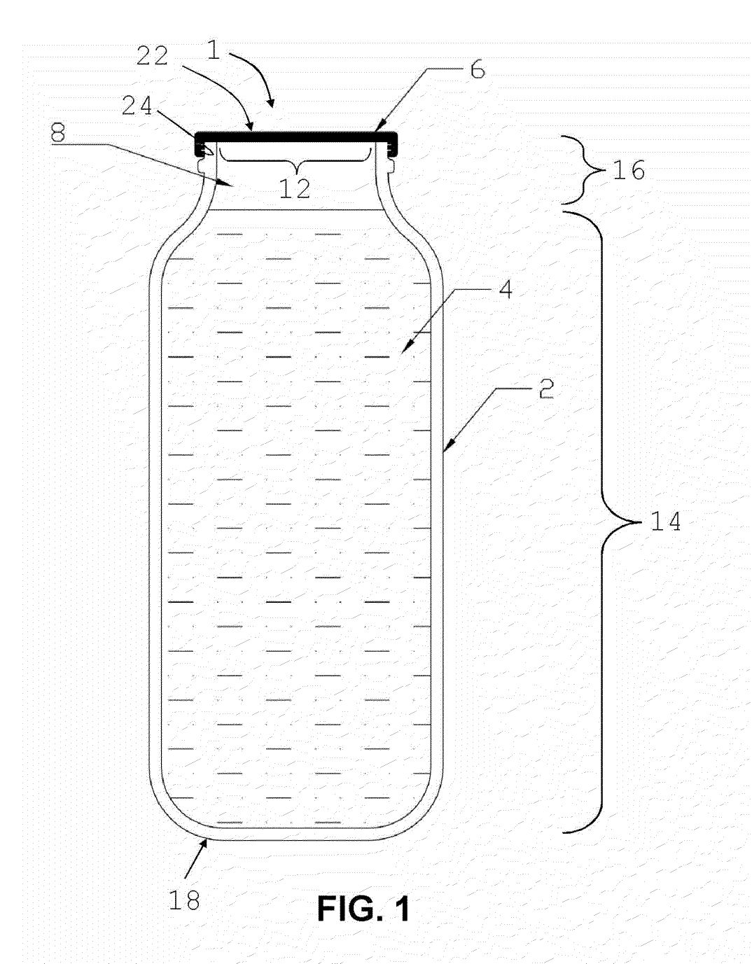

Referring to the Figures, and more particularly to FIGS. 1-6, a packaged hot-brewed coffee beverage 1 is provided that has the taste and aroma attributes of freshly brewed coffee, but that has an extended shelf-life such that it may be sold and stored for extended periods with or without being refrigerated. The packaged hot-brewed coffee or espresso beverage 1 consists essentially of the coffee or espresso extracted by hot-brewing and the water used to make the extraction. In certain embodiments, the packaged hot-brewed coffee or espresso beverage consists essentially of the coffee or espresso extracted by hot-brewing, the water used to make the extraction and a flavorant. The packaged hot-brewed coffee or espresso beverage 1 does not include any milk products or natural or artificial sweeteners, or a combination thereof.

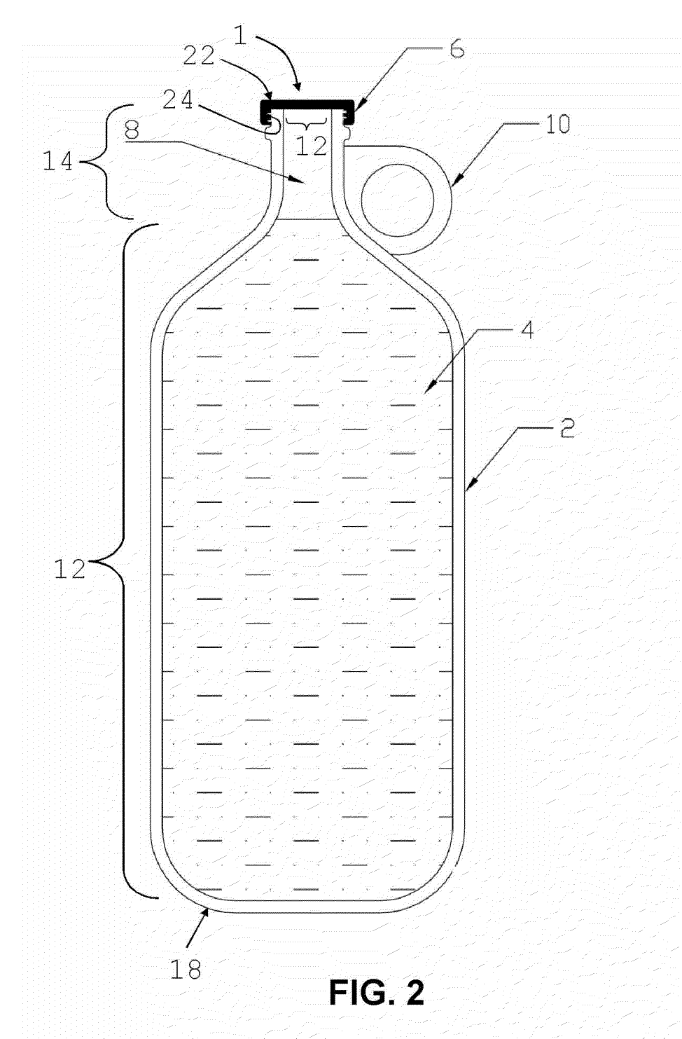

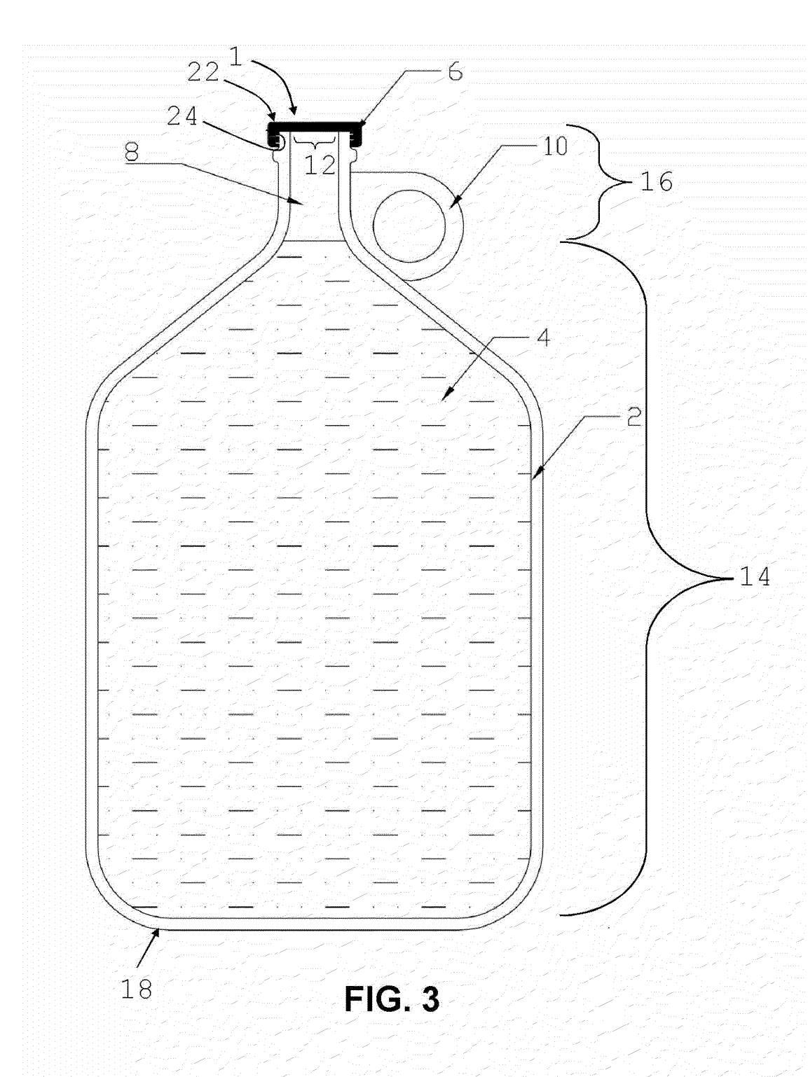

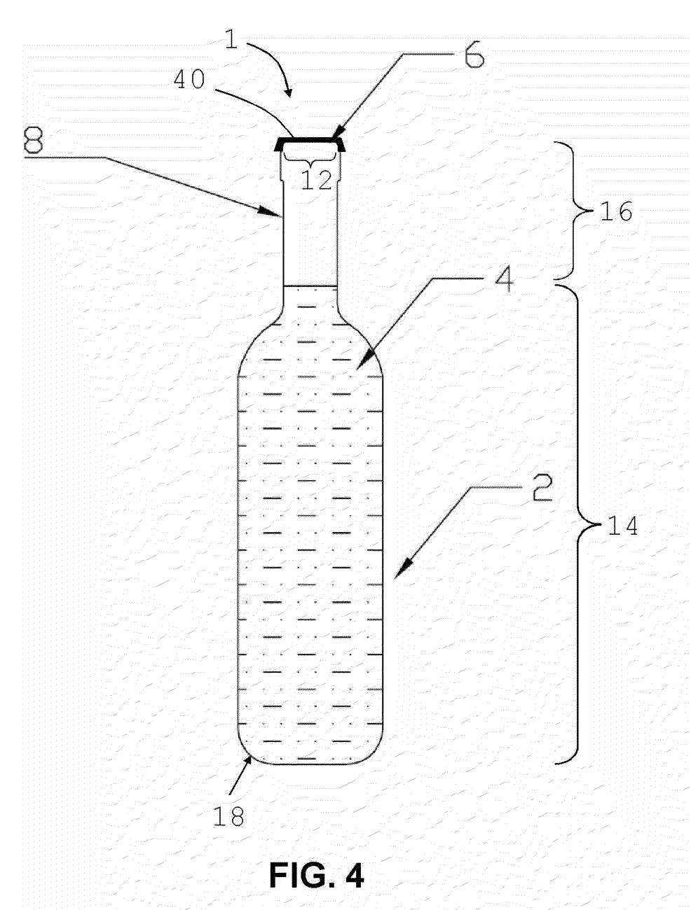

The packaged coffee beverage 1 includes a hollow aseptic or sterile container 2 having a base 3 and surrounding sidewalls 20 that extend upwardly and define a beverage cavity 8 and an outlet opening 12. The beverage cavity 8 includes a filled portion 14 that holds or contains the coffee beverage 4. The hollow sterile container 2 may have any suitable shape and size or capacity of the beverage cavity 8. Suitable shapes and sizes include all manner of conventional beverage container shapes and sizes, including those generally used for individual portion beverages, such as those having a capacity of 2 to 32 fluid ounces, as well as 0.5-1.0 l bottle configurations, for example, as shown generally in FIG. 1. Suitable shapes may also include those used for containers 2 large enough to hold multiple beverage portions, such as those having a capacity of 32 to 384 fluid ounces, as well as 1.0-3.0 l bottles or jugs, for example, including those having handles 10 to aid in pouring the beverage, as shown generally in FIGS. 2 and 3. In one embodiment, the beverage cavity 8 has a capacity of 2 fluid ounces to 20 gallons, and more particularly 6 fluid ounces to 384 fluid ounces, and even more particularly 8 fluid ounces to 128 fluid ounces. In one embodiment, the container 2 may have the shape of a beer or soda bottle and a capacity of 6 fluid ounces to 30 fluid ounces, and more particularly 12 fluid ounces to 24 fluid ounces, as shown generally in FIG. 4. Larger sterile bulk containers may also be used. Any suitable shape and size sterile bulk containers may be used, including those having a capacity of about 2 up to about 20 gallons. Any suitable material may be used to make the sterile container 2, including various glasses, ceramics, plastics, or metals, or a combination thereof. The material must be capable of undergoing temperatures sufficient to sterilize the coffee beverage and establish the aseptic environment without degradation, including treatment or cure temperatures from ambient up to about 250° F.

The packaged coffee beverage 1 includes an aseptic hot-brewed coffee beverage 4 comprising coffee and water, wherein the coffee is extracted from ground coffee beans by suitable hot-brewing process, as described herein. The hot-brewed coffee beverages 4 described herein may include those extracted by any suitable hot-brewing method, including methods that use liquid water at ambient pressure to produce coffee beverages, such as, for example, drip brewing, percolation, boiling. French-press, as well as methods that use liquid water and/or steam at pressures above ambient pressure (e.g. 9-10 atmospheres) for extraction, such as, for example, various espresso methods.

In one embodiment, where the hot-brewing method employs heated liquid water at ambient pressure, the hot-brewed coffee beverage 4 may have any suitable solubles concentration, including a solubles concentration of about 0.8% to about 2.0% and a solubles yield of about 14% to about 27%, and more particularly a solubles concentration of about 01.15% to about 1.5% and a solubles yield of about 18% to about 22%. The solubles concentration, solubles yield and other aspects of the hot-brewing process, such as, for example, the brewing ratio, may be measured in accordance with the standards set forth by the Specialty Coffee Association of America (SCAA). The hot-brewed coffee beverage 4 may be hot-brewed in any suitable brewing ratio of coffee and water, including being hot-brewed from coffee and water in a brewing ratio of 5 to 12 ounces of coffee per gallon of water.

In another embodiment, where the hot-brewing method employs liquid water and/or steam at pressures above ambient pressure for extraction. such as, for example, the hot-brewed beverage may comprise a hot-brewed espresso beverage 4. Any suitable hot-brewing conditions may be employed to provide the hot-brewed espresso beverage 4. The hot-brewed espresso beverage 4 has different characteristics, including a higher strength than a hot-brewed coffee beverage 4 because it employs higher extraction pressures and a much finer grind of the coffee, for example. While the hot-brewed espresso beverage 4 may be described with regard to a solubles concentration and yield, it is generally more desirable to describe the hot-brewed espresso beverage 4 with regard to a solids (including solubles) concentration and yield rather than a solubles yield, since the hot-brewing methods employed for espresso extraction provide a beverage with much higher amounts of undissolved coffee particles and emulsified oils. The hot-brewed espresso beverage 4 may have any suitable solids concentration, including a solids concentration of about 0.8% to about 2.0% and a solids yield of about 14% to about 27%, and more particularly a solids concentration of about 01.15% to about 1.5% and a solids yield of about 15% to about 25%. In addition, the hot-brewed espresso beverage 4 may have total dissolved solids of about 6% to about 35%, and more particularly about 8 to about 30%, and even more particularly about 11% to about 25%, and the total dissolved solids (i.e., coffee solids) in the water may vary as a function of the espresso brewing ratio, including the relative amounts of coffee and water employed during brewing.

The coffee used to hot-brew the coffee beverage may be from any suitable coffee bean, including Arabica or Robusta beans, or combinations thereof, and may include coffee beans grown in any country or geographic region of the world, such as, for example, Brazil, Vietnam, Columbia, Jamaica, Guatemala, Honduras, Mexico, Costa Rica, Ethiopia, Hawaii, India, or Indonesia, or combinations thereof. The coffee beans may have any suitable roast level, including light roast levels, such as cinnamon roast, New England roast and American roast that are roasted at low temperatures between about 383° F. to about 410° F., to heavy roast levels, such as French roast, Italian roast and Spanish roast that are roasted at high temperatures between about 464° F. to about 482° F. The roasted coffee beans may have any suitable grind, including extra-fine and fine grinds used for Turkish and espresso brewing, respectively, to medium-fine grinds used for vacuum pot brewing, and medium, medium-coarse and coarse grinds used for drip brewing and French press brewing, respectively.

The water used for hot-brewing the coffee to produce the hot-brewed coffee beverage 4 may be from any suitable water source, including various municipal or private water supplies. The water will preferably be selected to provide certain predetermined characteristics, including a predetermined mineral content, hardness, pH, alkalinity and sodium content, for use in the hot-brewing process and resultant hot-brewed coffee beverage 4, since these characteristics will significantly affect the taste and visual characteristics of the beverage. Preferred water sources will include those having the predetermined characteristics described, preferably with limited chlorination or fluorination, and most preferably with no chlorination or fluorination. Spring water from a predetermined water spring is particularly desirable, including water springs having low water hardness. It is desirable that the water have a predetermined mineral content, including total dissolved solids (TDS) but that the mineral content not be so high as to result in precipitation or deposition of lime scale or other mineral deposits on the walls of the container over time during storage of the hot-brewed coffee beverage 4 in the container 2. During the hot-brewing process solids are extracted from the coffee grounds and without consistent TDS levels, the quality of coffee and espresso can range greatly from strong and bitter to weak. Unless the TDS level is controlled, the consistency of the hot-brewed coffee beverage 4 will vary. In one embodiment, the water may have a predetermined amount of TDS between 50 ppm and 500 ppm, and more particularly 75 ppm to 250 ppm, and even more particularly 125 ppm to 175 ppm.

The water includes hardness ions, such as calcium and magnesium, that bind with the extracted coffee from the brewing process to give the correct flavor to the coffee or espresso beverage 4. Minerals also help to reduce the acidity of water. Without the proper amount of hard minerals the hot-brewed coffee or espresso beverage 4 will have a high level of astringency or be very bitter. Therefore, the water should include a predetermined amount of hardness, particularly calcium, and in one embodiment should include calcium hardness of 1 to 5 grains or 17 mg/L to 85 mg/L.

The acidity and alkalinity of the water is very important to the taste of the hot-brewed coffee or espresso beverage 4. A person with sensitive taste can notice a pH shift of as little as 0.1, so controlling pH is very important to beverage consistency and taste. Water below pH 7.0 is acidic and corrosive and water above 7.0 is basic and caustic. Higher pH also usually indicates a higher alkalinity and possibility of lime scale. In one embodiment, the pH is between 6.5 to 7.5, and more particularly between 6.7 and 7.3, and even more particularly 7. In one embodiment, the alkalinity is between 35 mg/L and 45 mg/L, and more particularly 40 mg/L.

The water should also have a predetermined sodium level to control the taste of the hot-brewed coffee or espresso beverage 4. In one embodiment, the amount of sodium in the water is 10 mg/L or less, and more particularly 5 mg/L to 15 mg/L, and more particularly 8 mg/L to 12 mg/L, and even more particularly 10 mg/L.

The hot-brewed coffee beverage 4 may also include a flavorant that may be added before, during, or after brewing. Any suitable flavorant may be used to impart a predetermined flavor characteristic to the hot-brewed coffee beverage 4. Suitable flavorants may include caramel, chocolate, white chocolate, brown sugar, cinnamon, gingerbread, hazelnut, almond, macadamia, walnut, vanilla, butter rum, butterscotch, chocolate, lemon, lime, orange, apple, banana, strawberry, raspberry, blackberry, blueberry, cranberry, lingonberry, cherry, pumpkin, spearmint, peppermint, Irish cream, amaretto, a liqueur, or other flavorant comprising alcohol, or a combination thereof. The flavorant, and the method of adding the flavorant will be selected to provide the desired flavor characteristic and be compatible with the hot-brewing process utilized, such that the flavorant does not react with the hot-brewed coffee beverage 4 so as to substantially diminish the appearance (e.g. by changing the appearance of the beverage by creating suspended particles to cause cloudiness or discoloration of the beverage) or storage life of the flavored, hot-brewed coffee beverage 4.

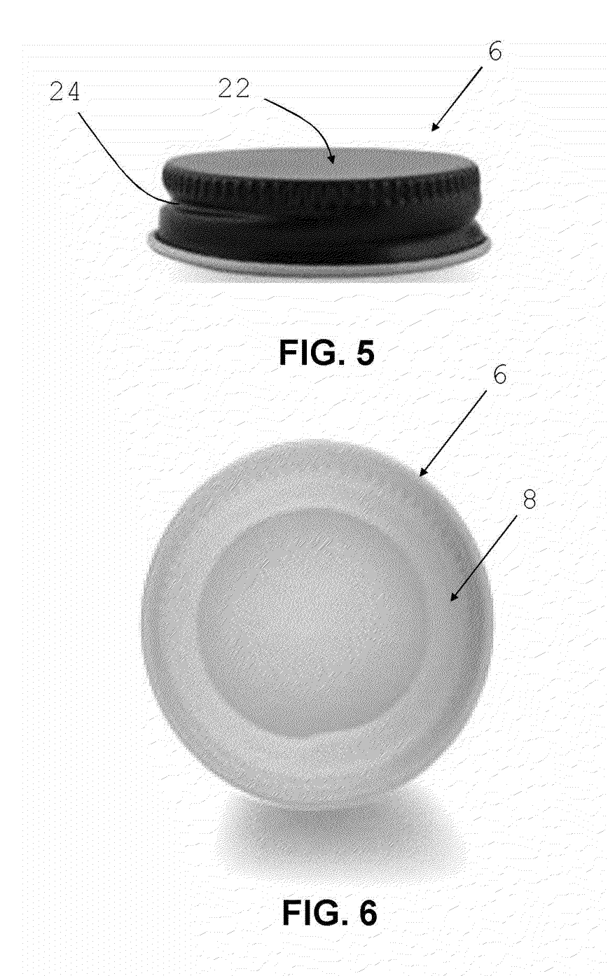

The hot-brewed coffee beverage 4 is sealed within the sterile beverage cavity 8 using a sealed closure 6 that is configured to maintain the aseptic environment within the beverage cavity 8. Referring to FIGS. 5 and 6, the sealed closure 6 includes a sealable cap 22, such as a threaded cap 24 that is configured to be screwed onto a mating threaded structure 26 of the container 2. The sealable cap 22 includes a seal 28 on its inner surface that is configured to seal against the rim 30 around the periphery 32 of the outlet opening 20. The sealed closure 6 is configured to maintain an aseptic environment within the beverage cavity 8, including both the filled portion 14 and the unfilled portion 16. In one embodiment, the sealed closure 6 is a vacuum seal lid configured to maintain a vacuum seal in the unfilled portion 16. In one embodiment, the vacuum seal lid is configured to provide an initial vacuum seal and is capable of being selectively removed and replaced once the initial vacuum seal is broken. In one embodiment, the sealed closure 6 is a single use closure. In another embodiment, the sealed closure is a multi-use closure. In one embodiment, such as that of the container 2 of FIG. 4, the sealed closure 6 is a pry-off or twist-off crimped cap 40. In one embodiment, the aseptic environment comprises a vacuum in the unfilled portion of the beverage cavity 8. In another embodiment, the aseptic environment comprises a substantially oxygen-free gas in the unfilled portion, such that free oxygen is substantially zero. In one embodiment, the substantially oxygen-free gas comprises nitrogen. In another embodiment, the substantially oxygen-free gas comprises an inert gas, such as argon.

The packaged (i.e. aseptic, sealed) hot-brewed coffee beverage may be stored with or without refrigeration for an indefinite period, which more particularly may include zero to ten years, and more particularly one month to five years, and even more particularly one month to two years. Preferred storage conditions for extended storage are similar to those employed for the storage of other bottled beverages, particularly wine, including avoidance of exposure to direct sunlight to reduce the possibility of light induced reaction with the components of the coffee, and storage at near ambient temperatures, including temperatures of about 77° F. (25° C.) or less, and more particularly between 50° F. and 69° F., and even more particularly between 50° F. and 59° F.

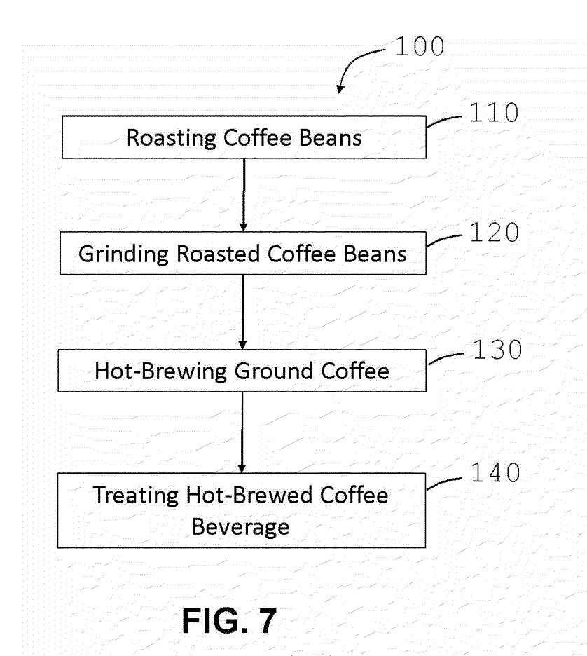

Referring to FIG. 7, the production of the packaged hot-brewed coffee beverage 1 includes a method 100 of roasting 110, grinding 120, hot-brewing 130, including separation or extraction and packaging 140. A plurality of processes may be used for many of these steps dependent on the type of coffee desired and availability of equipment.

Roasting 110 includes exposing green coffee beans to heat as described herein, typically a pan or specialized bean roaster, until the bean color changes to a dark brown. The resulting bean will be approximately twice the size as a fresh bean, and for higher temperature roasts oil will appear on the outside of the bean.

Grinding 120 involves reducing whole roasted coffee beans into grounds or a grind. The size of the individual coffee grounds varies dependent on the preferred type of brewing as described herein. Several different types of machines and grinding processes may be used dependent on the desired size of the grounds, ease of grinding, and other factors. One suitable grinding method include Burr-grinding where the coffee beans are crushed or torn between two revolving wheels. Relatively little frictional heating of the beans is created. This process gives an operator a wide selection of particle sizes. Another suitable grinding method includes chopping where the coffee beans are sliced with metal blades spun at a high RPM (revolutions per minute). Particle size is not consistent making this method less desirable. Another suitable grinding method including pounding where the coffee beans are pulverized or crushed to a fine powder. This method is used to make grounds suitable for Arabic and Turkish coffee that require very fine coffee particles which are unattainable by most other forms of grinding. Yet another method includes roller grinding where coffee beans are ground between one or more corrugated rollers. This method also limits frictional heat and is desirable for large scale grinding operations.

Hot-brewing 130 may be performed by any suitable hot-brewing process. The hot-brewing method may vary dependent on the type of coffee desired and availability of resources. Types of hot-brewing include decoction (through boiling), infusion (through steeping), gravitational percolation also known as drip brewing, or pressurized percolation also referred to as espresso. During hot-brewing 130 extraction occurs as the water is forced to make contact with ground coffee beans either by gravity, steam or pressure. The solvable particles dissolve and pass through the filter changing the water into liquid coffee. Factors including temperature of water and amount of coffee grounds are controlled for optimum efficiency and taste. The temperature of the water used for hot-brewing coffee may range between 195° F. to 205° F., and more particularly between 200° F. to 205° F. at ambient pressure. Espresso may be hot-brewed by forcing hot water at between 195° F. to 205 ° F. under a pressure of between eight and fifteen bars (800-1500 kPa, 116-220 psi), through a lightly packed matrix, called a “puck,” of very finely ground coffee.

Packaging 140 includes filling 142 the filled portion 14 of the container 2 with the hot-brewed coffee or espresso beverage 4, sealing 144 the container 2 with the sealed closure 6 and treating 146 the hot-brewed coffee or espresso beverage 4, container and sealed closure 6 to provide an aseptic environment within the beverage cavity 8. In order to ensure that the packaged hot-brewed coffee beverage 1 is aseptic, the hot-brewed coffee beverage 4, container 2 and sealed closure 6 must be suitably treated to provide the aseptic sterile environment. In addition, it is essential to ensure that the steps used to treat the hot-brewed coffee or espresso beverage 4, container 2 and sealed closure 6 do not degrade the taste or appearance of the beverage. Any suitable method of treating 146 the beverage, container 2 and sealed closure 6 may be used. However, because the hot-brewed coffee or espresso beverage 4 is already heated during the brewing process, various methods that employ heating to sterilize the container 2 are preferred. In one embodiment, the hot-brewed coffee beverage 4 may be flash pasteurized by heating it under pressure to a treatment or cure temperature of about 250° F. and then filling 142 and sealing 144 the container 2. In another embodiment, following extraction of the hot-brewed coffee beverage 4 filling is performed followed by sealing the container 144. Treating 146 of the packaged hot-brewed coffee beverages 1 is then performed by heating them under pressure, such as by use of a pressure cooker, to a treatment or cure temperature of about 250° F. and a pressure above ambient pressure to provide the aseptic, packaged hot-brewed coffee beverages 1.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

1. An aseptic, hot-brewed, packaged coffee or espresso beverage, comprising:
a hollow sterile container having a base and an outlet opening, the container having a beverage cavity;
an aseptic, hot-brewed coffee or espresso beverage having a solubles concentration of about 0.8% to about 2.0% and a solubles yield of about 14% to about 27%, the beverage partially filling the beverage cavity to provide a filled portion and an unfilled portion and
a sealed closure, the sealed closure configured to maintain an aseptic environment in the beverage cavity.

2. The packaged coffee or espresso beverage of claim 1, wherein the aseptic environment comprises a vacuum in the unfilled portion.

3. The packaged coffee or espresso beverage of claim 1, wherein the aseptic environment comprises a substantially oxygen-free gas.

4. The packaged coffee or espresso beverage of claim 3, wherein the gas comprises nitrogen.

5. The packaged coffee or espresso beverage of claim 3, wherein the gas comprises an inert gas.

6. The packaged coffee or espresso beverage of claim 1, wherein the container also comprises a pouring spout proximate the base, the outlet opening disposed in the pouring spout.

7. The packaged coffee or espresso beverage of claim 1, wherein the brewed coffee beverage is brewed from coffee and water in a brewing ratio of about 5 to about 12 ounces of coffee per gallon of water.

8. The packaged coffee or espresso beverage of claim 1, wherein the brewed coffee beverage has a solubles concentration of about 01.15% to about 1.5% and a solubles yield of about 18% to about 22%.

9. The packaged coffee or espresso beverage of claim 1, wherein the closure is a vacuum seal lid.

10. The packaged coffee or espresso beverage of claim 1, wherein vacuum seal lid is configured to provide an initial vacuum seal and is capable of being selectively removed and replaced once the initial vacuum seal is broken.

11. The packaged coffee or espresso beverage of claim 1, wherein the sealed closure is a single use closure.

12. The packaged coffee or espresso beverage of claim 1, wherein the sealed closure is a multi-use closure.

13. The packaged coffee or espresso beverage of claim 1, wherein the beverage cavity has a capacity of about 2 fluid ounces to about 20 gallons.

14. The packaged coffee or espresso beverage of claim 13, wherein the beverage cavity has a capacity of about 6 fluid ounces to about 384 fluid ounces.

15. The packaged coffee or espresso beverage of claim 13, wherein the beverage cavity has a capacity of about 8 fluid ounces to about 128 fluid ounces.

16. The packaged coffee or espresso beverage of claim 1, further comprising a flavorant.

17. The packaged coffee or espresso beverage of claim 16, wherein the flavorant comprises caramel, chocolate, white chocolate, brown sugar, cinnamon, gingerbread, hazelnut, almond, macadamia, walnut, vanilla, butter rum, butterscotch, chocolate, lemon, lime, orange, apple, banana, strawberry, raspberry, blackberry, blueberry, cranberry, lingonberry, cherry, pumpkin, spearmint, peppermint Irish cream, amaretto, a liqueur, or other flavorant comprising alcohol, or a combination thereof.

18. The packaged coffee or espresso beverage of claim 1, wherein the sterile container comprises, glass, ceramic, plastic, or metal, or a combination thereof.

19. The packaged coffee beverage of claim 1, wherein the aseptic environment in the unfilled portion of the beverage cavity comprises an anaerobic environment.

20. An aseptic, hot-brewed, packaged espresso beverage, comprising:
a hollow sterile container having a base and an outlet opening, the container having a beverage cavity;
an aseptic, hot-brewed espresso beverage having a solids concentration of about 0.8% to about 2.0% and a solids yield of about 14% to about 27%, the beverage partially filling the beverage cavity to provide a filled portion and an unfilled portion; and
a sealed closure, the sealed closure configured to maintain an aseptic environment in the beverage cavity.
